(19) United States
(12) Patent Application Publication
(10) Pub. No.: US 2014/0132883 A1
(43) Pub. Date: May 15, 2014

(54) OPTICAL STACK INCLUDING LIGHT EXTRACTION LAYER AND POLYMER DISPERSED LIQUID CRYSTAL LAYER

(71) Applicant: 3M INNOVATIVE PROPERTIES COMPANY, St. Paul, MN (US)

(72) Inventors: RALPH R. ROBERTS, COTTAGE GROVE, MN (US); BRIAN T. WEBER, SAINT PAUL, MN (US)

(73) Assignee: 3M INNOVATIVE PROPERTIES COMPANY, ST. PAUL, MN (US)

(21) Appl. No.: 13/675,130

(22) Filed: Nov. 13, 2012

(51) Int. Cl. G02F 1/1335

(52) U.S. Cl. CPC G02F 1/133606
USPC 349/62

(57) ABSTRACT

Optical stacks are described. More specifically, optical stacks including a lightguide, a light extraction layer having first and second regions, and a polymer dispersed liquid crystal layer having third and fourth regions are described. One or more of the first and second regions of the light extraction layer may be in registration with one or more of the third and fourth regions of the polymer dispersed liquid crystal layer.

### BACKGROUND

In lighting, display, and architectural elements, there is a need for visually attractive surfaces, panels, and luminaires that are good illuminators, provide interesting visual features, or offer both. Light extraction layers, specifically clear or transparent light extraction layers, allow for the design of display or lighting elements that may efficiently extract light while minimally distorting and scattering light. Polymer dispersed liquid crystal layers may impart a high haze appearance while turning transparent after application of voltage to the layer.

### SUMMARY

In one aspect, the present disclosure describes an optical stack. The optical stack includes a light guide and a light extraction layer optically coupled to the lightguide having first and second regions, the first and second regions being disposed such that the variable index light extraction layer selectively extracts guided mode light from the lightguide based on the geometric arrangement of the first and second regions. The optical stack further includes a polymer dispersed liquid crystal layer optically coupled to the light extraction layer having third and fourth regions, wherein at least one of the third and fourth regions has a haze value dependent on a voltage applied to the at least one of the third and fourth regions of the polymer dispersed liquid crystal layer. In some embodiments, one or more of the first and second regions of the light extraction layer is in registration with one or more of the third and fourth regions of the polymer dispersed liquid crystal layer.

### BRIEF DESCRIPTION OF THE DRAWINGS

FIG. 1 is a schematic cross-sectional elevation view of an edge-lit system.

FIG. 2 is a schematic cross-sectional elevation view of a lightguide with a light extraction layer.

FIG. 3 shows the general operational principles of the configuration of FIG. 2.

FIGS. 4A and 4B are schematic cross-sectional elevation views of a lightguide with a polymer dispersed liquid crystal layer.

FIGS. 5A and 5B show the general operational principles of the configuration of FIGS. 4A and 4B, respectively.

FIG. 6 is a schematic cross-sectional elevation view of a lightguide with a light extraction layer and a polymer dispersed liquid crystal layer.

FIGS. 7A and 7B show the general operational principles of the configuration of FIG. 6.

FIG. 8 is an alternative configuration of a lightguide with a light extraction layer and a polymer dispersed liquid crystal layer.

FIGS. 9A, 9B, 9C, and 9D show four operational states of the configuration of FIG. 6 or 8.

FIGS. 10A, 10B, 10C, and 10D show four exemplary configurations showing registration of the light extraction layer and the polymer dispersed liquid crystal layer.

FIG. 11 is a schematic of a process for forming shaped polymer dispersed liquid crystal layers.

FIGS. 12A, 12B, 12C, and 12D are top plan views of different states of an optical stack having multiple stacked polymer dispersed liquid crystal layers.

FIGS. 13A, 13B, and 13C are images of exemplary patterns used in forming polymer dispersed liquid crystal layers.

FIGS. 14A, 14B, 14C, 14D, 14E, and 14F are images of a polymer dispersed liquid crystal layer having discrete zones.

FIGS. 15A, 15B, 15C, and 15D are images of a polymer dispersed liquid crystal layer having multiple layers and discrete zones.

### DETAILED DESCRIPTION

Embodiments of the present disclosure include a lightguide, a light extraction layer optically coupled to the lightguide, where the light extraction layer has first and second regions disposed such that the variable index light extraction layer selectively extracts guided mode light from the lightguide based on the geometric arrangement of the first and second regions. A polymer dispersed liquid crystal layer may be optically coupled to the light extraction layer, where the polymer dispersed liquid crystal layer has third and fourth regions and at least one of the third and fourth regions has a haze value dependent on a voltage applied to the at least one of the third and fourth regions of the polymer dispersed liquid crystal layer. Additionally, in some embodiments of the present disclosure, one or more of the first and second regions of the light extraction layer is in registration with one or more of the third and fourth regions of the polymer dispersed liquid crystal layer.

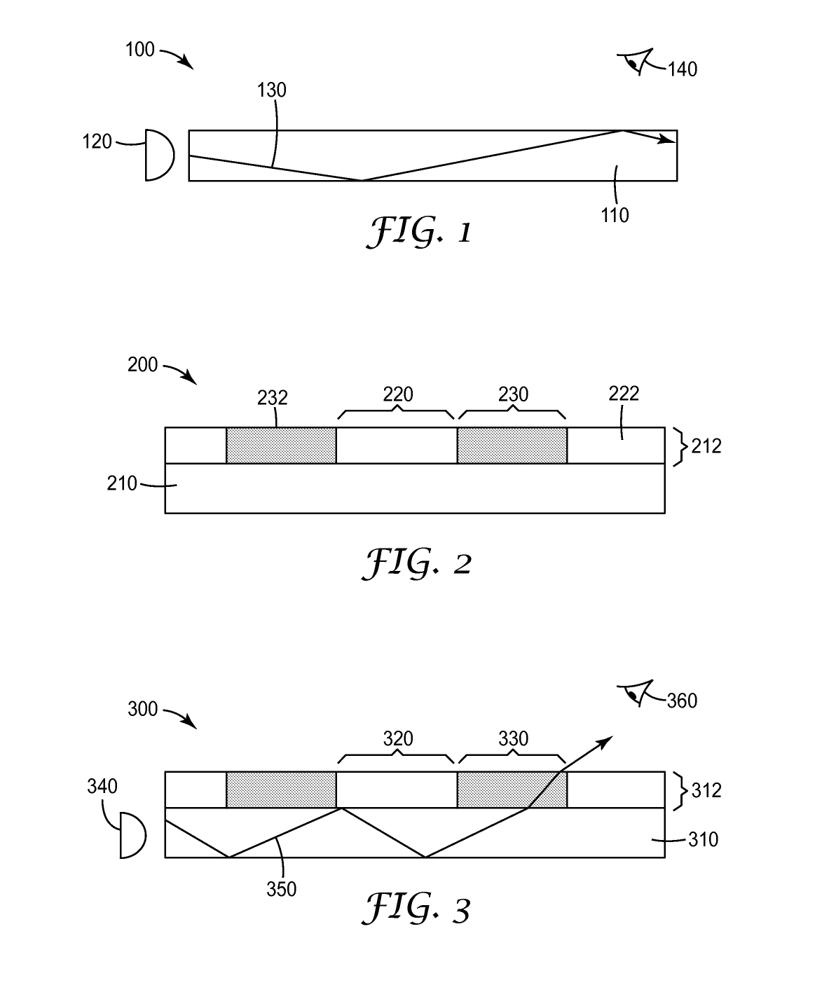

FIG. 1 is a schematic cross-sectional view of edge-lit system 100. Edge-lit system 100 includes lightguide 110, one or more light sources 120 emitting or otherwise injecting ray 130 into lightguide 110, and observer 140 represented by an eye.

Lightguide 110 may be any suitable shape and constructed or formed from any suitable material. In some embodiments, lightguide 110 may be formed from a polymer, including homopolymers or copolymers of polyethylene terephthalate (PET), polyethylene naphthalate (PEN), acrylic, polycarbonate, cyclo-olefin polymers, and silicons. Many transparent materials are suitable for use as lightguide 110, including viscoelastic materials such as hot melt or pressure sensitive adhesives, as described in, for example, U.S. Patent Publication No. 2011-0176325 A1 (Sherman et al.), entitled “Viscoelastic Lightguide.” Lightguide 110, shown as substantially planar in FIG. 1 for ease of illustration, may also be any suitable shape, including having curved, beveled, or otherwise non-flat surfaces or sides.

One or more light sources 120 may be any number of suitable light sources. In some embodiments, one or more light sources 120 includes a light emitting diode, or LED. In other embodiments, one or more light sources 120 may include an incandescent bulb or a cold cathode fluorescent lamp (CCFL). One or more of the light sources of one or more light sources 120 may be colored or have a certain wavelength. In some applications, it may be desirable to generate colored light for decorative or ornamental purposes. In other applications, a non-visible, e.g., ultraviolet bulb can be used in conjunction with a phosphor which may absorb some of the ultraviolet light and reemit light in the visible spectrum. In some embodiments, multiple light sources emitting different wavelengths may be advantageously used to create the appearance of white light. In some embodiments, one or more light sources 120 may be ambient or natural light.

If one or more light sources 120 is external to lightguide 110, it may be desirable to provide collimation or injection optics, possibly including a structured surface on lightguide 110 to prevent wasteful reflection on an external surface of lightguide 110. Injection optics may allow light incident on lightguide 110 at an otherwise supercritical angle to enter and propagate within lightguide 110.

Exemplary light ray 130 is shown to illustrate the general operational principles of edge-lit system 100. Light ray 130, originating from one or more light sources 120, is propagating within the lightguide. For interfaces where light is going from a higher index of refraction medium to a lower index of refraction medium, a critical angle exists where light incident at supercritical angles is totally internally reflected (reflected through TIR). In FIG. 1, lightguide 110 is illustrated as being bounded on both its major surfaces by air. Because air has a lower index of refraction than those used to form lightguide 110, the light propagating at supercritical angles is totally internally reflected and bounces within lightguide 110.

Because little or no light is extracted through the surfaces of lightguide 110, observer 140 will not perceive lightguide 110 being illuminated from one or more light sources 120. If lightguide 110 contains few or no distorting or scattering elements, observer 140 will perceive lightguide 110 as transparent and any object or element on the opposite side of lightguide 110 will be clearly visible. Observer 140, while represented by an eye, need not be a human eye. In some embodiments, observer 140 may be replaced with a remote sensor, detector, or even another optical component, film, or stack.

FIG. 2 is a schematic cross-sectional elevation view of a lightguide with a light extraction layer. Optical stack 200 includes lightguide 210 (corresponding with lightguide 110 of FIG. 1) and light extraction layer 212. Light extraction layer includes non-extracting regions 220 including first substance 222 and extracting regions 230 including second substance 232.

Non-extracting regions 220 and extracting regions 230 may be different in composition, configuration, or both. In some embodiments, non-extracting regions 220 and extracting regions 230 may have different optical or physical properties. For example, non-extracting regions 220 may have a lower index of refraction than extracting regions 230. Further, non-extracting regions 220 may have a lower index (or effective index) of refraction than lightguide 210 through the use of either low-index materials or substances, high-index material substantially interspersed with low-index materials, including air, or both. These characteristics may allow for light to be selectively extracted based on the geometric arrangement of these regions, as described in, for example, U.S. Patent Application Ser. No. 61/446,712, entitled “Illumination Article and Device for Front-Lighting Reflective Scattering Element” and filed Feb. 25, 2011 and U.S. Provisional Patent Application Ser. No. 61/655,208, entitled “Variable Index Light Extraction Layer with Microreplicated Posts and Methods of Making the Same” and filed Jun. 4, 2012.

Alternatively or additionally, extracting regions 230 may have a structured surface on either major surface (either the same side as lightguide 210 or the opposite side) while non-extracting regions 220 may have a different structured surface or may lack one altogether (i.e., may be smooth). In some embodiments, extraction regions 230 may have diffractive features configured to extract guided mode light from lightguide 210, while non-extracting regions 220 may have a lower diffractive surface feature refractive index, or may lack diffractive features altogether. Configurations of diffractive light extraction layers are described in, for example, U.S. Provisional patent application Ser. No. 13/572,813, entitled “Lighting Devices with Patterned Printing of Diffractive Extraction Features” and filed Aug. 13, 2012.

While non-extracting regions 220 and extracting regions 230 are shown as substantially equal in size, shape, and thickness, this need not be the case for constructions and configurations of light extraction layer 212. FIG. 2 is only intended to be a schematic indicating the basic geometric arrangement of light extraction layer 212. For example, in some edge-lit embodiments, it may be desirable to configure light extraction layer 212 as a gradient, with the areal density of extracting regions 230 increasing with distance from the light source. In other embodiments, while FIG. 2 only illustrates an exemplary cross-section of optical stack 200, light extraction layer 212 may include non-extracting regions 220 and extracting regions 230 that are shaped or curved, which may create targeted illumination intensities for different areas. In some embodiments, light extraction layer 212 may be configured that portions of extracting regions 230, portions of non-extracting regions 220, or both are shaped or configured to display indicia, such as a message, symbol, or company logo. This includes both the indicia being illuminated (i.e., corresponding with extracting regions 230) and non-illuminated but viewable in contrast (i.e., corresponding with non-extracting regions 220). Further, while it may be advantageous for manufacturing or optical coupling, light extraction layer 212 need not be of uniform thickness. In some embodiments, light extracting layer 212 is curved, shaped, or tapers at one or more ends of optical stack 200.

First substance 222 and second substance 232 may be chosen from a wide range of suitable materials, including air. First substance 222 and second substance 232 may be selected in order to impart desired optical characteristics to non-extracting regions 220 and extracting regions 230, respectively. For example, first substance 222 may include a low-index material such as a nanoporous or a nanovoided polymeric material, described in, for example, U.S. Patent Application Ser. No. 61/446,740, entitled “Front-Lit Reflective Display Device and Method of Front-Lighting Reflective Display,” and filed Feb. 25, 2011. When first substance 222 has a lower index of refraction than adjacent lightguide 210 and is configured suitably within non-extracting regions 220, guided mode light propagating in lightguide 210 may undergo total internal reflection at the interface between lightguide 210 and non-extracting regions 220, preventing light from being extracted through those areas. Similarly, second substance 232 may include a higher-index material, including optical adhesives, inks, polymeric substances, organic and inorganic substances, or any other suitable material. In some embodiments, the second substance 232 may be selected to have an index of refraction similar to or greater than lightguide 210. Guided mode light will thereby generally be refracted through extracting regions 230 instead of totally internally reflected, allowing light to pass out through extracting regions 230. It may be desirable in some applications to match the indices of refraction of second substance 232 and lightguide 210 in order to minimize distortion.

Second substance 232 may include the same base material as first substance 222, but with modifications to alter one or more of its properties. For example, second substance 232 may include a nanovoided polymeric material and a high index ink printed into its nanovoids. Examples of printing substances into nanovoided polymeric material is described in, for example, U.S. Patent Application Ser. No. 61/485,881, entitled “Back-Lit Transmissive Display Having Variable Index Light Extraction Layer” and filed May 13, 2011. One or both of first substance 222 and second substance 232 may also be selected for its physical properties, such as melting point, warp resistance, flexibility, or ability to be adhered to easily adhered or attached to other surfaces or films.

FIG. 3 illustrates the general operational principles of the optical stack of FIG. 2. Edge-lit system 300 includes lightguide 310, light extraction layer 312 including non-extracting regions 320 and extracting regions 330 (corresponding to light extraction layer 212, non-extracting regions 220, and extracting regions 230 in FIG.2), and one or more light sources 340 emitting exemplary light ray 350.

Exemplary light ray 350 is propagating through the lightguide as guided mode light. First, exemplary light ray 350 is incident on an interface between lightguide 310 and surrounding air. Because the interface is from a higher index of refraction to a lower index of a refraction and exemplary ray 350 is incident on that interface at a supercritical angle, exemplary ray 350 is totally internally reflected. Likewise, when exemplary ray 350 is incident on the interface between lightguide 310 and non-extracting region 320, the optical properties of non-extracting region 320 are such that exemplary ray 320 is internally reflected at that interface as well. While exemplary ray 350 is depicted as being reflected exactly at the interface between non-extracting regions 320 and lightguide 310, depending on the features or configuration of lightguide 310 and non-extracting regions 320, exemplary ray 350 may be reflected anywhere within non-extraction regions 320.

Exemplary light ray 350 is once again totally internally reflected at the interface between lightguide 310 and surrounding air. Propagating exemplary light ray 350 is subsequently incident on extracting regions 330. In some embodiments, because extracting regions 330 have a higher index of refraction than lightguide 310, incident light is refracted within extracting regions 330 and then extracted out of optical stack 300 such that exemplary ray 350 is no longer propagating within lightguide 310. The refraction of exemplary light ray 350 within extracting regions 330 may be less than depicted in the schematic of FIG. 3; the refraction is exaggerated to make it clearly visible. In some embodiments, light extraction layer 312 is the top layer of optical stack 300 and exemplary ray 350 enters the surrounding air or other medium after leaving light extraction layer 312. In other embodiments, optical stack 300 is incorporated into another film stack of coupled to one or more optical elements, and extraction refers to exemplary ray 350 no longer propagating within lightguide 310.

Light extracted out of optical stack 300 through extracting regions 330 may be visible to observer 360. If light extraction layer 312 includes a pattern of non-extracting regions 320 and extracting regions 330 that have sufficiently small dimensions, then from the perspective of observer 360, optical stack 300 may appear to be uniformly emitting light and not in fact patterned. In other words, light extraction layer 312 may appear to have only one extracting region: while lightguide 310 and light extraction layer 312 do not in fact generate any light, it may appear this way to observer 360. Depending on the application, it may be desirable to either arrange light extraction layer 312 such that the arrangement of non-extracting regions 320 and extracting regions 330 are visible or such that they are not visible to observer 360.

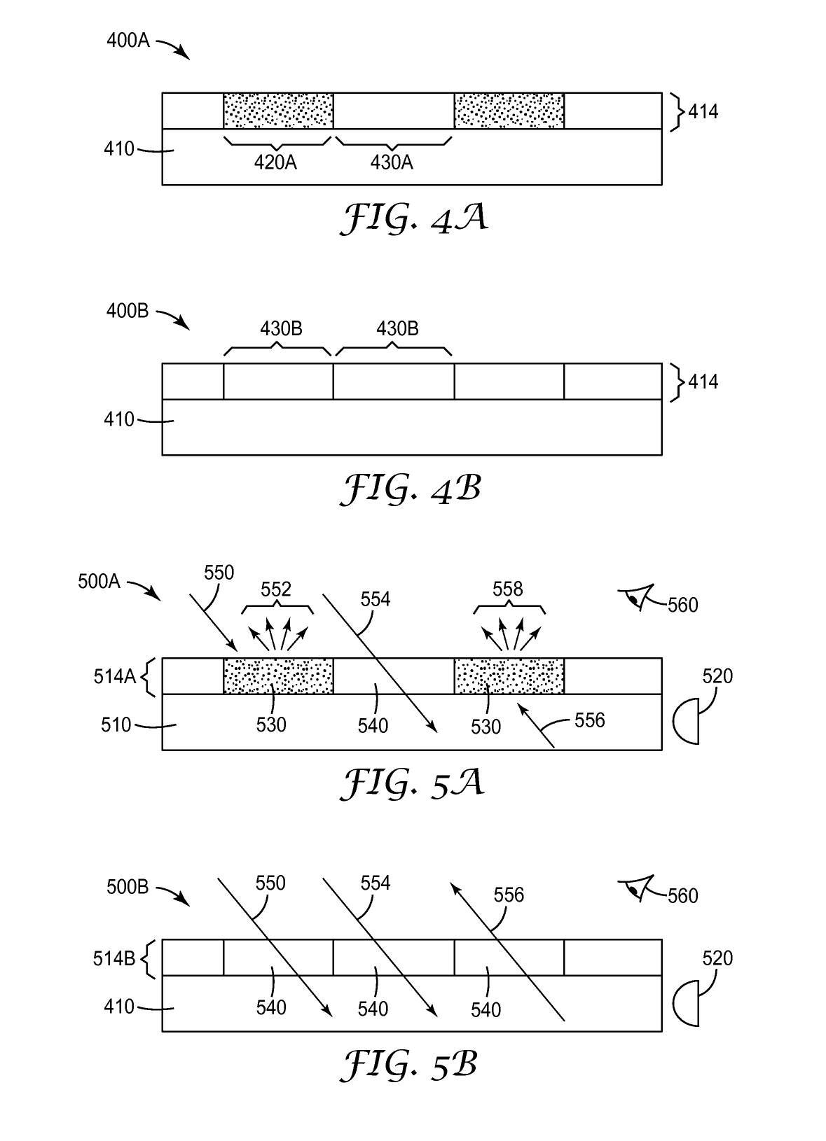

FIGS. 4A and 4B are schematic cross-sectional elevation views of a lightguide with a polymer dispersed liquid crystal (PDLC) layer. First optical stack 400A includes lightguide 410 and polymer dispersed liquid crystal layer 414 which includes high-haze zones 420A and low-haze zones 430A. Second optical stack 400B includes lightguide 410 and polymer dispersed liquid crystal layer 414 including low-haze zones 430B.

Polymer dispersed liquid crystal layer 414 includes droplets of liquid crystal dispersed in a polymer matrix. Polymer dispersed liquid crystal layers function by having an electric field applied across the layer such that a change in the orientation of the dispersed liquid crystal droplets takes place. Control of electric field in such layers may be achieved by sandwiching the polymer dispersed liquid crystal between two transparent conductive films functioning as electrodes, utilizing materials such as indium tin oxide (ITO), which may be patterned or etched to accommodate two or more electrically isolated regions or zones. Transparent spacer beads may be included to preserve the two conductive films from touching each other. In some embodiments, the layer is translucent or has high haze in the “off” state, i.e., without the application of voltage, due to light scattering by the refractive index mismatch between the polymer matrix and the dispersed liquid crystal droplets. When the electric field is applied, i.e., when the layer is in the “on” state, the liquid crystalline droplets align to the electric field, causing the refractive index mismatch between the liquid crystalline droplets and the polymeric matrix to decrease such that the layer become transparent or substantially transparent, or at least has low haze.

FIG. 4A corresponds to a first state of optical stack 400A, or, more specifically, a state where some of polymer dispersed liquid crystal layer 414 is depicted in an off state. Polymer dispersed liquid crystal layer 414 includes two types of zones: high-haze zones 420A and low-haze zones 430A. High-haze zones 420A are zones of polymer dispersed liquid crystal with no electric field applied, or, more specifically, without a sufficient electric field to orient the liquid crystal droplets. In some embodiments, low-haze zones 430A may have an electric field which causes liquid crystal droplets to orient. In these embodiments, high-haze zones 420A and low-haze zones 430A may be electrically isolated. In other words, an electrical field applied to one zone does not affect the other, or at least does not affect it sufficiently to disrupt its desired haze state. In other embodiments, low-haze zones 430A may simply not contain dispersed liquid crystal droplets, maintaining low-haze zones 430A as substantially transparent regardless of the application of an electric field. In these cases, low-haze zones 430A may include any suitable material, including polymers, optical inks, adhesives, and the like.

FIG. 4B may correspond to optical stack 400A of FIG. 4A with different electrical input within polymer dispersed liquid crystal layer 414. As compared to FIG. 4A, high-haze zones 420A are now substantially transparent as low-haze zones 430A.

Because haze values of portions of polymer dispersed liquid crystal layer 414 may depend on electric fields applied across the layer, portions of polymer dispersed liquid crystal layer 414 may be considered “switchable” or “active.” Depending on the configuration of polymer dispersed liquid crystal layer 414, switchable portions, i.e., portions that may be switched from high-haze zones 430A to low-haze zones 420A, may be arranged in any suitable pattern or configuration. In some embodiments, switchable portions of polymer dispersed liquid crystal layer 414 may be disposed, shaped, or sized such that in some states, indicia may be displayed in high-haze zones 430A, such as a message or company logo. In some embodiments, these indicia may be instead displayed in low-haze zones 420A. Because portions may be controlled independently, one or more indicia may be displayed simultaneously, or different indicia may be displayed in different modes or states. Similarly, in some embodiments, a state may be possible where all of or a significant portion of polymer dispersed liquid crystal layer 414 is substantially transparent or, conversely, highly diffuse and hazy.

FIGS. 5A and 5B illustrate the general operational principles of the configurations of FIGS. 4A and 4B, respectively. Edge-lit system 500A includes lightguide 510, polymer dispersed liquid crystal layer 514A including high-haze zones 530 and low-haze zones 540, one or more light sources 520, first ray 550 producing first scattered light 552, second ray 554, and third ray 558 producing second scattered light 558. FIG. 5B illustrates a similar system, edge-lit system 500B; however, polymer dispersed liquid crystal layer 514B includes only low-haze zones 540. Accordingly, no light is significantly scattered by polymer dispersed liquid crystal layer 514B.

In FIG. 5A, first ray 550 is incident on one of high-haze zones 530, corresponding to high-haze zones 420A in FIG. 4A. Because no or an insufficient electrical field is applied across high-haze zones 530, a refractive index difference remains between the dispersed liquid crystal droplets and the polymer matrix. This difference produces a highly diffuse reflection, resulting in first scattered light 552. Observer 560 may perceive scattered light 552 as a hazy illumination, similar to a sheet of waxed paper or frosted glass. While a component of first ray 550 may continue forward into lightguide 510, this has little effect on the appearance of edge-lit system 500A to observer 560.

Second ray 554 is incident on one of low-haze zones 540, corresponding to low-haze zones 430A in FIG. 4A. Because an electric field is applied across low-haze zones 540, or because low-haze zones 540 do not include dispersed liquid crystal droplets, light is not scattered while passing through low-haze zones 540. Low-haze zones 540 will appear substantially transparent to observer 560. If lightguide 510 is also transparent, observer 560 may be able to view whatever is on the opposite side of lightguide 510, including a graphic or other indicia. While second ray 554 may be refracted at the interface between air and polymer dispersed liquid crystal layer 514A, this effect is not illustrated in FIGS. 5A and 5B because it has little effect on the appearance of low-haze zones 540 and edge-lit 500A generally to observer 560.

Third ray 556 is within lightguide 510. In some embodiments, third ray 556 is emitted or injected into lightguide 510 by one or more light sources 520. Third ray 556 is incident on one of high-haze zones 530 and, like first ray 550, is diffusely scattered into second scattered light 558. Again, while there may be a component of third ray 556 reflected back into the lightguide, such reflections are not directly relevant to what observer 560 perceives when looking at edge-lit system 500A.

In FIG. 5B, polymer dispersed liquid crystal layer 514B does not include high-haze zones 530 like in FIG. 5A. Instead, polymer disposed liquid crystal layer is depicted as including only low-haze zones 540. As described in conjunction with FIGS. 4 and 5A, high-haze zones 420A and 530 scatter light, while low-haze zones 430A, 430B , and 540 generally do not. Correspondingly, first ray 550 and second ray 554 both pass through polymer dispersed liquid crystal layer 514B and lightguide 510 without significant reflection or redirection. Similarly, third light ray 556, which in some embodiments may be emitted by one or more light sources 520, is not redirected, scattered, or reflected when leaving lightguide 510 through one of low-haze zones 540. Observer 560 may perceive third ray 556 as illumination while the appearance of edge-lit system 500B or, more specifically, polymer dispersed liquid crystal layer 514B and lightguide 510, remains transparent.

The electric field dependence of haze values in portions of polymer dispersed liquid crystal layer 514B may be used to configure or design desired applications with switchable haze values. In some embodiments, FIG. 5A may represent an edge-lit display or luminaire with the electric field across polymer dispersed liquid crystal layer 514A turned off. Likewise, FIG. 5B may, in some embodiments, represent an edge-lit display or luminaire with the electric field turned on. Switching between the modes illustrated in FIG. 5A and FIG. 5B may be as simple as controlling or switching an electrical field attached to selected portions.

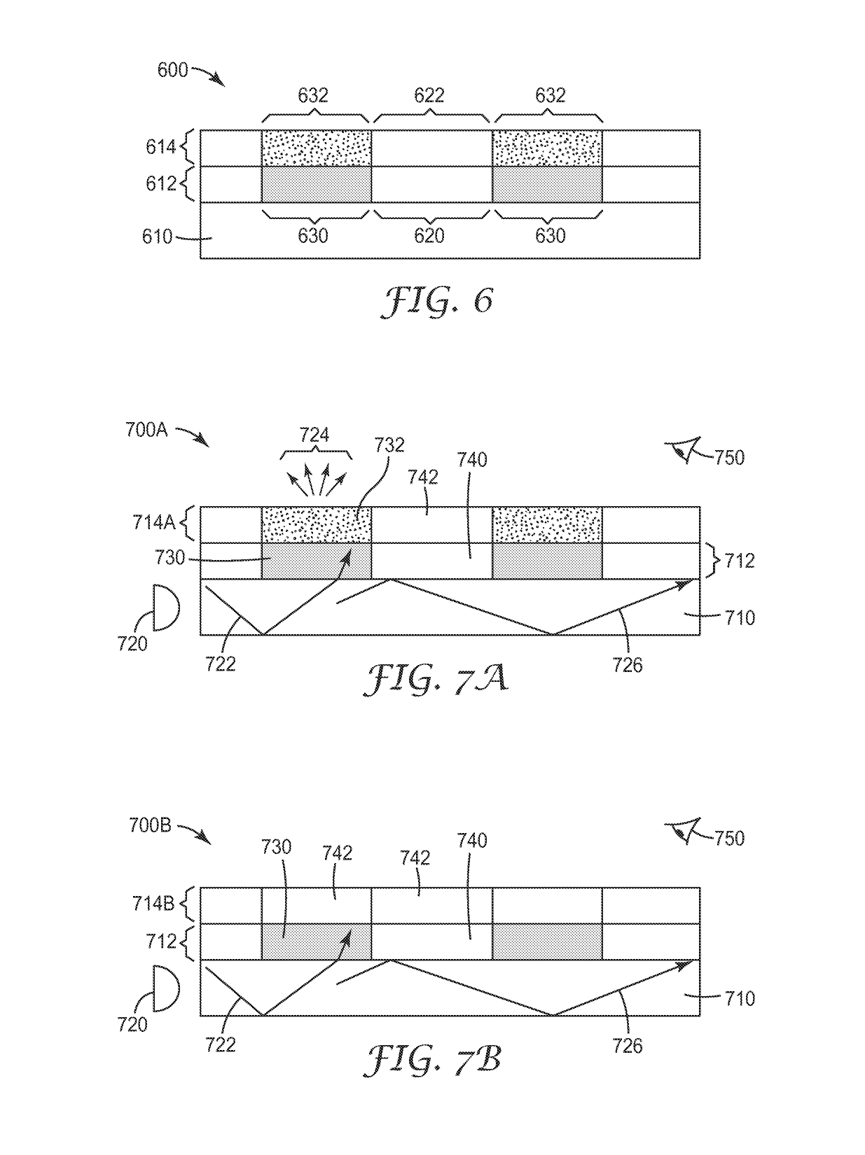

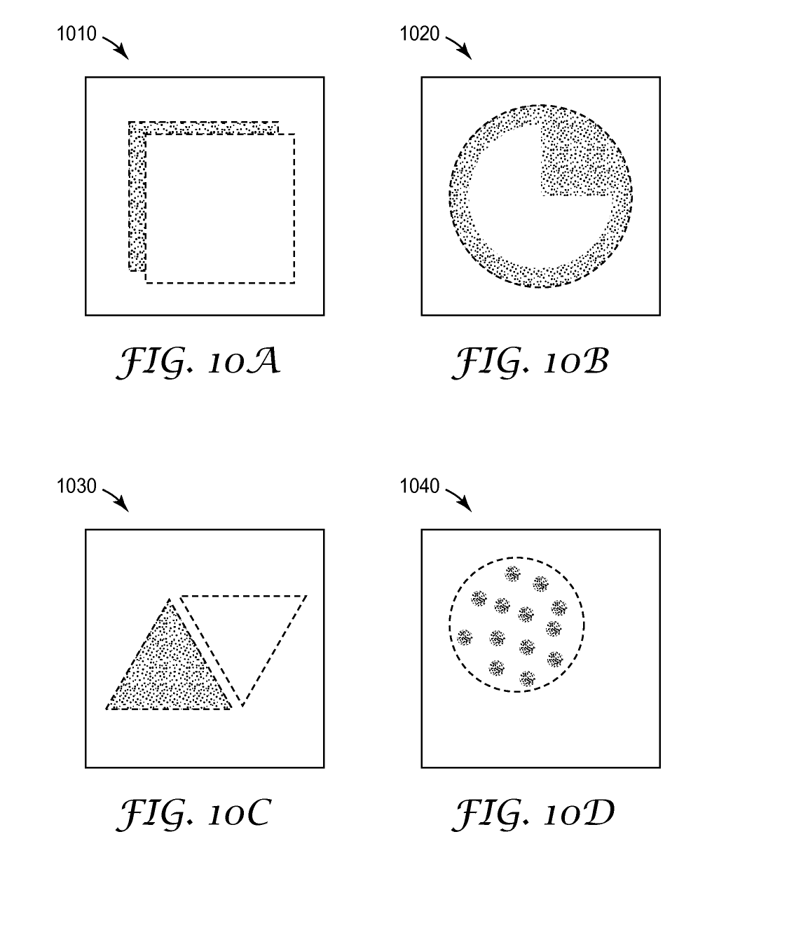

FIG. 6 is a schematic cross-sectional elevation view of a lightguide including a light extraction layer and a polymer dispersed liquid crystal layer. Optical stack 600 includes lightguide 610, light extraction layer 612 including non-extracting regions 620 and extracting regions 630, and polymer dispersed liquid crystal layer 614 including low-haze zones 622 and high-haze zones 632. The configuration and arrangements of either or both of light extraction layer 612 and polymer dispersed liquid crystal layer 614 may be selected to impart desired optical or aesthetic properties to optical stack 600. For example, in some embodiments, extracting regions 630 and high-haze zones 632 may be registered to one another; in other words, the two areas may be related to one another in terms of one or more of shape, size, or position. As depicted in FIG. 6, these areas may be related in all of these characteristics. Registration is discussed in more detail in conjunction with FIG. 10. Lightguide 610, light extraction layer 612, and polymer dispersed liquid crystal layer 614 may be attached to one another with any suitable adhesive or lamination. In some embodiments, some or all of lightguide 610, light extraction layer 612, and polymer dispersed liquid crystal layer 614 may be itself an adhesive or otherwise aid in the attachment of that layer to others in optical stack 600. Any extra layer or adhesive incorporated into optical stack 600 may be selected to have the same or similar index of refraction as one or more adjacent layers to minimize or prevent distortion or refraction for light traveling through the stack.

FIGS. 7A and 7B illustrate the general operational principles of the configuration of FIG. 6. Both edge-lit system 700A and edge-lit system 700B include lightguide 710, light extraction layer 712 including extracting regions 730 and non-extracting regions 740, and one or more light sources 720 producing first ray 722 and second ray 726. Edge-lit system 700A, depicted in FIG. 7A, includes polymer dispersed liquid crystal layer 714A including high-haze zones 732 and low-haze zones 742. Similarly, edge-lit system 700B includes polymer dispersed liquid crystal layer 714B including only low-haze zones 742. In some embodiments, the configuration of FIG. 7A may represent a high-haze or off state of the configuration of FIG. 7B.

In FIG. 7A, first ray 722 may be emitted by one or more light sources 720. First ray 722 is totally internally reflected at the interface between lightguide 710 and surrounding air. Next, first ray 722 is incident on one of extracting regions 730 and consequently refracted and extracted through light extraction layer 712. After, first light ray 722 is incident on one of high-haze zones 732. Because high-haze zones 732 are diffusely reflective, first light ray 732 produces scattered light 724. To observer 750, this should appear as hazy illumination. Conversely, second ray 726, which may also be emitted by one or more light sources 720, is incident on one of non-extracting zones 740 and is therefore not extracted through light extraction layer 712. Second ray 726 continues to propagate through lightguide 710 without having been extracted. As shown in the schematic of FIG. 7A, the light that exits edge-lit system 700A travels through one of high-haze zones 732. Therefore, observer 750 will perceive edge-lit system 700A as producing or displaying diffuse light.

In FIG. 7B, first ray 722 is similarly extracted through light extraction layer 712 through one of extracting regions 730. Because in this embodiment, however, polymer dispersed liquid crystal layer 714B includes only low-haze zones 742, first ray 722 is not diffusely scattered when passing through polymer dispersed liquid crystal layer 714B. Observer 750 will perceive edge-lit system 700B as emitting light, but the light will not be diffuse. Similarly, because no significant hazy elements are present in the configuration shown in FIG. 7B, observer 750 will perceive edge-lit system 700B as being substantially transparent. As in FIG. 7A, second ray 726 in FIG. 7B is incident on one of the non-extracting zones 740 and continues to propagate within lightguide 710 without being extracted.

For both FIGS. 7A and 7B, if non-extracting zones 740 are very small, the areas where light in not being extracting may not be easily apparent to observer 750, who would perceive uniform light coming from the edge-lit system, regardless of whether or not it were diffuse. In some embodiments, it may be desirable to offset high-haze zones 732 slightly to compensate for the directional light emitted by one or more light sources 720. In other words, because light propagating in lightguide 710 will likely retain at least a component of the propagation direction, high-haze zones 732 may be shifted slightly to compensate for the distance in the propagation direction travelled by light while in extracting zones 730.

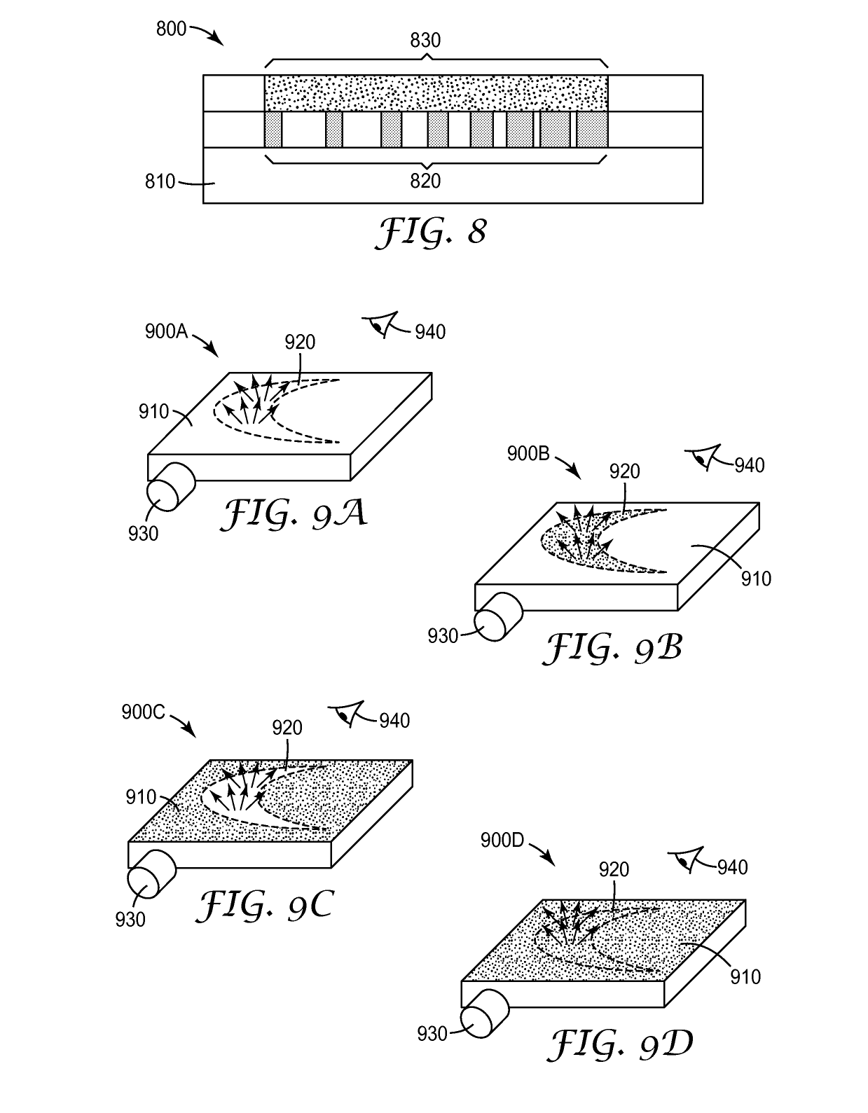

FIG. 8 is a schematic cross-sectional elevation view of an optical stack similar to that of FIG. 6. Optical stack 800 includes lightguide 810, light extracting region 820, and high-haze zone 830. FIG. 8 illustrates that light extracting regions, while depicted in other figures as a single, unbroken area of light extraction, may itself include a gradient. In some applications, configuring light extracting regions as a gradient may allow for increased uniformity of light. As shown in FIG. 8, the areal density of the darker regions (the darker regions corresponding with light extracting regions described in other figures) increases as a function of position. Such a configuration may be desirable where one or more light sources were positioned or configured to have light propagate through lightguide 810 from left to right. The initially lower areal density may help to prevent the premature extraction of light and instead ensure the light is extracted over all of the area of high-haze zone 830. Any depictions or descriptions of light extracting regions in this disclosure may instead be configured as some sort of pattern or gradient. Further, in the configuration of FIG. 8, light extracting region 820 and high-haze zone 830 may still be considered to be in registration with one another. In other words, the gradient depicted in FIG. 8 as light extracting region 820 may be considered to be a single body instead of discrete alternating areas of extracting and non-extracting optical properties.

FIGS. 9A-9D are top perspective views illustrating four exemplary modes of operation of an embodiment of this disclosure. Edge-lit systems 900A, 900B, 900C, and 900D each include optical stack 910, indicium 920, and one or more light sources 930. General appearances are discussed from the perspective of observer 940.

In FIGS. 9A-9D, indicium 920 represents an embodiment where the extracting regions of a light extraction layer and the high-haze zones of a polymer dispersed liquid crystal layer are registered or otherwise aligned. In this embodiment, both shapes coincide and form a crescent moon, which, in other embodiments, could be any logo, design, graphic, or shape. Note that the crescent moon may not be the only region of either polymer dispersed liquid crystal or light extracting character; in fact, in some embodiments, as depicted in FIGS. 9A-9D, the zone outside of indicium 920 may have its haze level controlled independently. Nonetheless, in the embodiments depicted in FIGS. 9A-9D, indicium 920 is illuminated due to its registration with a light extracting region, while other regions correspond to non-extracting regions of a light extraction layer included in optical stack 910.

In FIG. 9A, light emitted or injected into optical stack 910 by one or more light sources 930 is extracted over an area corresponding to indicium 920. Observer 940 may perceive edge-lit system 940 as substantially transparent over the entire surface of optical stack 910, with light emanating from indicium 920. If optical stack 910 includes a polymer dispersed crystal layer corresponding either to indicium 920 or to the region outside of indicium 920, it may have an electric field applied across the layer, resulting in a substantially transparent and low-haze appearance to observer 940.

In FIG. 9B, a polymer dispersed liquid crystal layer having a region corresponding to indicium 920 has no electric field or has had its electric field removed, and therefore has reverted back to a high-haze state. Light emitted or injected into optical stack 910 by one or more light sources 930 is, as in FIG. 9A, extracted in the region corresponding to indicium 920, through the high-haze zone. Observer 940 may perceive edge-lit system as producing a hazy or diffuse light through indicium 920 with neither illumination nor haze detectible outside indicium 920.

In FIG. 9C, a polymer dispersed liquid crystal layer corresponding to the area outside indicium 920 has no electric field or has had its electric field removed while the area corresponding to indicium 920 has an electric field applied across this zone of polymer dispersed liquid crystal. Accordingly, the zone corresponding with indicium 920 is low-haze while the zone corresponding with the area outside indicium 920 is high-haze. As in FIGS. 9A and 9B, indicium 920 is registered to an extracting region of a light extraction layer, resulting in light being extracted in the shape of the crescent moon. Observer 940 may perceive indicium 920 as illuminated but substantially transparent or low-haze, while the area outside of indicium 920 is hazy but not illuminated.

In FIG. 9D, a polymer dispersed liquid crystal layer included in optical stack 910 has no electric field or has had its electric field removed covering both the area corresponding to indicium 920 and the area outside indicium 920. Therefore, the entire surface of optical stack 910 visible to observer 940 appears hazy and diffusely reflective. Again, as in FIGS. 9A-9C, the area corresponding to indicium 920 is registered to an extracting area of a light extraction layer included in optical stack 910, causing observer 940 to perceive edge-lit system 900D as having a hazy, illuminated indicium surrounded by a hazy, non-illuminated region.

All of FIGS. 9A-9D may, in some embodiments, represent different states of a single configuration of the present disclosure. In other words, while indicium 920 remains illuminated across each figure, each of FIGS. 9A-9D depicts a different configuration of two zones of polymer dispersed liquid crystal (i.e., the area corresponding to indicium 920 and the area surrounding indicia 920) which may be dependent on the electric field applied across that particular zone. The flexibility and interchangeability in display modes may be advantageous or desirable in creating eye-catching and interesting dynamic displays, signs, luminaires or other optical systems.

FIG. 10 depicts several exemplary configurations to show the breadth of possibilities of light extraction layers and polymer dispersed liquid crystal layers being in registration. In each of first configuration 1010, second configuration 1020, third configuration 1030, and fourth configuration 1040, dashed lines surrounding an area signifies an extracting zone for a light extraction layer. As in other figures, a shaded area indicates a polymer dispersed liquid crystal layer (shown in high-haze state for ease of illustration). The configurations shown in FIG. 10 are merely exemplary and both variations of those depicted and completely different arrangements are contemplated. For example, any or all of the configurations shown in FIG. 10 may have their haze values inverted; i.e., low-haze zones and high-haze zones may be reversed from how they are shown.

FIG. 10 shows four exemplary arrangements of light extracting zones and polymer dispersed liquid crystal zones, all of which may be considered in registration because they are related in one or more of size, shape, or position. First configuration 1010 depicts a drop-shadow type pattern. The hazy border may surround part or most of the non-hazy portion and give the impression of depth or that two squares are superimposed or stacked. In some embodiments, the illuminated, non-hazy square in the center of first configuration 1010 may be in any suitable shape, including a symbol, letter, or company logo.

Second configuration 1020 depicts an outline-type pattern. As shown in FIG. 10, the light extracting zone may contain both a high-haze zone and a low-haze zone, with the former surrounding the latter. In some embodiments, the inner, low-haze zone may correspond to a shape, symbol, letter, or other indicia; in other embodiments, the outer, high-haze zone may instead correspond to this shape. Both the inner and outer zone may correspond to separate, though possibly related symbols, such as a word mark within a graphic, both associated with a company or a product.

Third configuration 1030 illustrates an arrangement that uses haze values for contrast. While both shapes are illuminated, and while the light extraction zones correspond tightly with the desired shape, the left triangle provides diffuse, hazy light while the right has a low haze value and may appear transparent. The shapes may be any suitable symbol or indicia, whether identical, similar, or different.

Fourth configuration 1040 illustrates an arrangement that has a polka dot pattern of high-haze zones within a circle of light extraction. While fourth configuration 1040 depicts the hazy dots as being rather large and distinct, in some embodiments the smaller shapes may be sufficiently tiny to remain unresolved by an observer, which may create an appearance of texture or impart an interesting pattern to the area.

In some embodiments, the transparent conductive electrodes of the polymer dispersed liquid crystal layer may be preshaped. FIG. 11 shows an embodiment of a manufacturing process that starts with two transparent electrodes having tabs at the top. The two electrodes may be affixed at the bottom, flat end, polymeric liquid crystal composition is applied and then the two electrodes may be laminated together. After lamination and curing, the provided display screen may by shaped by cutting as shown in FIG. 11. In this embodiment, polymer dispersed liquid crystal layers shaped like bottles are produced with the tops of the bottles having two separate shaped electrodes to which leads can be attached. In certain manufacturing processes the inclusion of fiducials or fiduciary marks may help with alignment of layers during assembly.

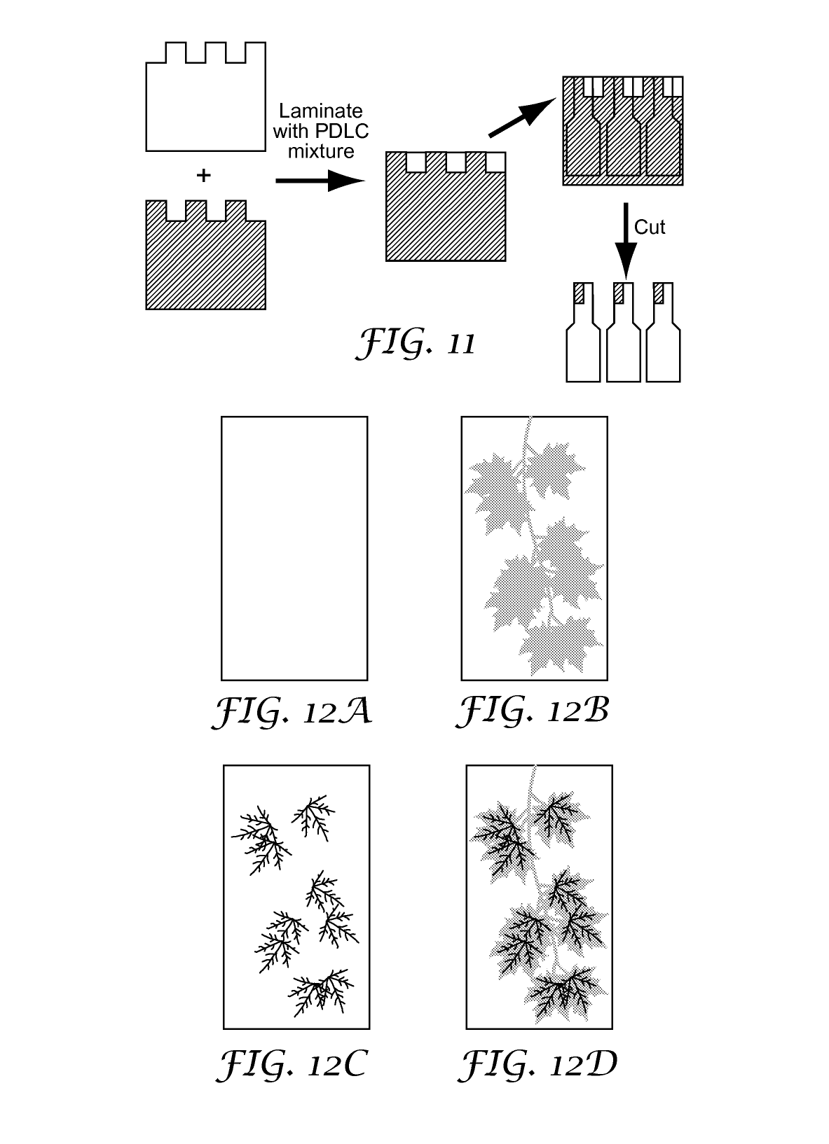

For embodiments of the present disclosure, it is possible to get intermediate levels of haze by overlaying two or more provided polymer dispersed liquid crystal layers to produce a composite PDLC layer. FIGS. 12A-12D show a composite PDLC layer made by overlaying two provided polymer dispersed liquid crystal layers (layer 1 and layer 2). FIG. 12A is an illustration of the image of a composite PDLC layer where each layer is in a low-haze state. No image is observable in the composite PDLC layer. FIG. 12B is an image of the composite PDLC layer with layer 1 (having a pattern of leaves) in a high-haze state and layer 2 in a low-haze state). FIG. 12C is an image of the composite PDLC layer with layer 2 (having a pattern of leaf veins) in a high-haze state and layer 1 in a low-haze state. When layer 1 and layer 2 are both in a high-haze state, the result is a single composite PDLC layer appearing as is illustrated in FIG. 12D. Shaped screens and multi-layered PDLC configurations are described in jointly owned patent application, Attorney Docket No. 71068US002, filed on even date herewith.

### EXAMPLES

Materials

| Abbreviation/product | | |
|---|---|---|
| name | Description | Available from |
| ITO on PET | 127 μm (5 mil) Polyethylene | 3M Company, St. Paul, MN |
| | Terephthalate (PET) coated with | |
| | Indium Tin Oxide (ITO) at a | |
| | resistivity of 100 Ohms/sq | |
| NOA65 | Norland Optical Adhesive 65 | Norland Products, Inc., Cranbury, NJ |
| BL036 | Liquid crystal | E. Merck KG, Darmstadt, Germany |
| Micro Pearl SP | Plastic spacer beads | Sekisui Chemical Co., Ltd., Osaka, |
| | | Japan |
| PELCO | PELCO Conductive Liquid | Ted Pella, Inc., Redding, CA |
| | Silver Paint | |
| 3M 8141 OCA | Optically clear adhesive | 3M Company, St. Paul, MN |
| POST-IT tape | Removable tape | 3M Company, St. Paul, MN |
| Nalco 2327 | Colloidal silica in 1-methoxy-2- | Nalco Chemical Company, |
| | propanol, 43.40 wt % solids | Naperville IL |
| MELINEX 617 | 50 μm PET film | DuPont Teijin Films, Hopewell, VA |
| CN 9893 | Aliphatic urethane acrylate | Sartomer Corporation, Exton, PA |
| Silquest A-174 | Silane | GE Advanced Materials, Wilton, CT |
| SR 444 | Pentaerythritol triacrylate | Sartomer Corporation, Exton, PA |
| DOWANOL PM | Propylene glycol methyl ether | Dow Chemical, Midland, MI |
| Ethyl acetate | Ethyl acetate | Sigma-Aldrich Chemical Company, |
| | | Milwaukee, WI |
| 1-methoxy-2-propanol | 1-methoxy-2-propanol | Sigma-Aldrich Chemical Company, |
| | | Milwaukee, WI |
| IRGACURE 184 | Photoinitiator | BASF Corporation, Florham Park, NJ |
| IRGACURE 819 | Photoinitiator | BASF Corporation, Florham Park, NJ |
| UV OP1005 GP | UV curable varnish | Nazdar, Shawnee, KS |

### Preparation of Patterned PDLC

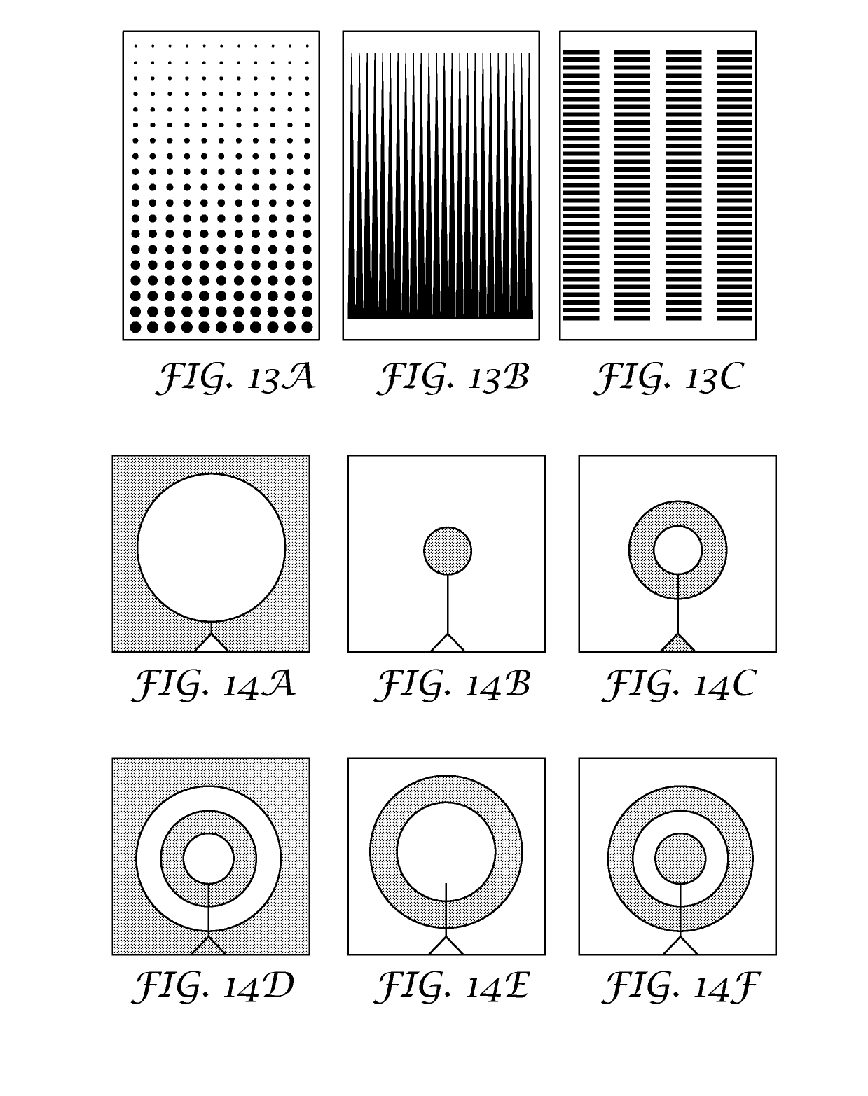

Using an ESI 5200 laser (available from ESI, Portland, Oreg.) with a 32 mA power setting, patterns as shown in FIG. 13A-13C were etched onto an ITO on PET substrate. Patterned PDLC film was made using the following procedure.

To a solution containing approximately equal amounts (by mass) of NOA65 adhesive and BL036 liquid crystal was added 2% (by weight of combined NOA65 and BL036) Micro Pearl SP spacer beads having a diameter of either 6 μm or 10 μm depending on the desired cell gap. The resulting solution was sonicated for 1 hour in a 40° C. water bath. During sonication, the pattern was cut from the sheet of ITO on PET. The pattern was affixed to a common (un-patterned ITO sheet) with POST-IT tape and leads were cut out. The pattern-common stack was gently cleaned with isopropanol (IPA) and a stream of air.

After sonication, approximately 1.5 mL of solution was applied across the common (with stack held open) near the point of attachment of the two substrates. Care was taken to apply the solution evenly, although more solution was added near the center. The pattern was laid back down and the stack gently smoothed to spread out the solution. The stack was then laminated between polyester liners using a Laminex 27 inch MINIKOTE laminator (available from Laminex, Fort Mill, S.C.) at 30.5 cm/min (1.0 ft/min). No heat was used during lamination.

After lamination the stack was gently wiped to remove excess solution. The stack was then UV cured (one-sided, on a piece of Lexan) for 10 minutes at 1.0 mW/cm². After curing the PDLC was cleaned with IPA. Small dots of PELCO were added on the leads of the pattern and the common and allowed to dry.

### Preparation of A-174 Nalco 2327 Silica Nanoparticles

In a 2 L three neck flask, equipped with a condenser and a thermometer, 750 g of Nalco 2327 colloidal silica and 700 g of 1-methoxy-2-propanol were mixed together under rapid stirring. After that, 61.59 g of Silquest A-174 silane was added, and then the mixture was stirred for 10 min., followed by addition of 400 g of 1-methoxy-2-propanol. The mixture was heated at 85° C. for 6 hours using a heating mantle. The resulting solution was allowed to cool down to room temperature. The water and some of the 1-methoxy-2-propanol was removed under vacuum using a rotary evaporator and a 60° C. water bath. The resulting sol was a clear dispersion that was 43.4% wt A-174 modified 20 nm silica in 1-methoxy-2-propanol.

### Preparation of Coating Formulation

The following were added in a 1-liter wide-mouth amber bottle: 5.70 g of CN 9893 and 22.40 g of SR 444. The bottle was capped and shaken for 2 hours to dissolve CN 9893 (batch is clear). This solution is referred to as Resin Premix.

The following were added to a 2000 mL poly bottle: 482.84 g of the sol prepared as described above and the Resin Premix. The two components were mixed by transferring the batch back and forth between two bottles, ending with the batch in the 2000 mL bottle. To the 2000 mL bottle was added 5.84 g of IRGACURE 184 and 1.12 g of IRGACURE 819. The solution was shaken for 30 minutes to dissolve photoinitiators. The resulting batch was a translucent, low-viscosity dispersion.

The dispersion was diluted to ˜17.7% solids by weight with a 50/50 blend ethyl acetate and DOWANOL PM.

### Preparation of Nanovoided Polymeric Layer

The above coating formulation was coated onto 50 μm PET film (MELINEX 617) using a slot die at a line speed of 3.1 m/ min. The wet coating thickness was approximately 8.1 μm. In an inert chamber (<50 ppm O₂), the wet coating was partially cured in-line at the same line speed with UV radiation at 395 nm and dose of 850 mJ/cm². (UV radiation was provided by UV-LEDs available from Cree, Inc.). The partially cured coating sample was then dried at 70° C. in a 9 meter oven, and under a nitrogen-purged atmosphere, finally cured with a 236 Watt/cm² Fusion H bulb (available from Fusion UV Systems, Inc.). The resulting nanovoided polymeric layer had a thickness of 1.3 μm. The transmission was 96.4%, the haze was 1.33% and the clarity was 99.7% as measured using a BYK-Gardner HAZE GARD PLUS (Columbia, Md.). The refractive index of the nanovoided layer was between 1.200 and 1.220 as measured at 589 nm using a Metricon Prism Coupler (Metricon Corporation, Pennington, N.J.).

### Formation of Variable Index Light Extraction Layer on Transparent Substrate

The nanovoided polymeric layer is printed with a UV curable clear ink (UV OP1005 GP) using an indirect gravure printing process. A flexographic tool having a dot pattern with a density variation chosen to align with a desired pattern in a PDLC layer is fabricated (by Southern Graphics Systems) based on a .pdf image that defines the desired pattern. A gravure roll (pyramidal and 9 cubic μm per square μm) is rated to give a wet coating of approximately 9.65 μm. The printing is done at 10 meters per minute with high intensity UV curing under a nitrogen-purged atmosphere with a 236 Watt/cm² Fusion H bulb (available from Fusion UV Systems, Inc.) after the printing. The resulting printed layer is an optical film comprising: first regions having a first refractive index and comprising nanovoided polymeric material, and second regions wherein the nanovoids are filled or partially filled with the cured clear ink, the second regions having a second refractive index greater than that of the first regions.

### Example 1

### Zones in PDLC

PDLC film was prepared as described in “Preparation of Patterned PDLC” and was laminated onto clear acrylic using 3M 8141 OCA. The pattern consisted of a center circle, two concentric rings and an area outside outermost ring as shown in FIG. 14A-14F. By selectively applying voltage to leads associated with the center circle, each ring, and on the area outside the outer ring, each area was independently switched between hazy and clear states.

The % Transmittance (% T) and % Haze (% H) of the PDLCs were measured at 0V, 32V, and 64V using a HAZE-GARD PLUS meter available from BYK-Gardner Inc. of Silver Springs, Md., which complies with ASTM D1003-07e1 “Standard Test Method for Haze and Luminous Transmittance of Transparent Plastics”. The results are reported in the table below. Each value represents the average of 4 measurements taken from the center circle, on each ring, and on the outside the outer ring.

| | Cell Gap | | | |
|---|---|---|---|---|
| | 6 μm | | 10 μm | |
| Voltage | % T | % H | % T | % H |
| 0 V | 77 | 85.2 | 72.7 | 94.8 |
| 32 V | 80.5 | 6.27 | 79.8 | 12.5 |
| 64 V | 81.1 | 5.04 | 80.7 | 6.45 |

Extraction Layer

A printed clear extraction layer is prepared as described in “Formation of variable index light extraction layer on transparent substrate.” The printed clear extraction layer is then laminated to the PDLC film using 3M 8141 OCA such that the pattern in the PDLC film and the pattern in the printed clear extraction layer align.

### Example 2

### Shaped Screen

PDLC film patterned in the shape of a bottle was prepared as described in “Preparation of Patterned PDLC.” The bottle shape was cut out of the film using scissors and was laminated to clear acrylic using 3M 8141 OCA.

Extraction Layer

A printed clear extraction layer is prepared as described in Example 1 with the pattern in the printed clear extraction layer selected to match the bottle shape in the PDLC layer. The printed clear extraction layer is then cut to match the shape of the bottle screen and is laminated to the PDLC film using 3M 8141 OCA such that the shape in the PDLC film and the shape of the printed clear extraction layer align.

### Example 3

### PDLC Layers

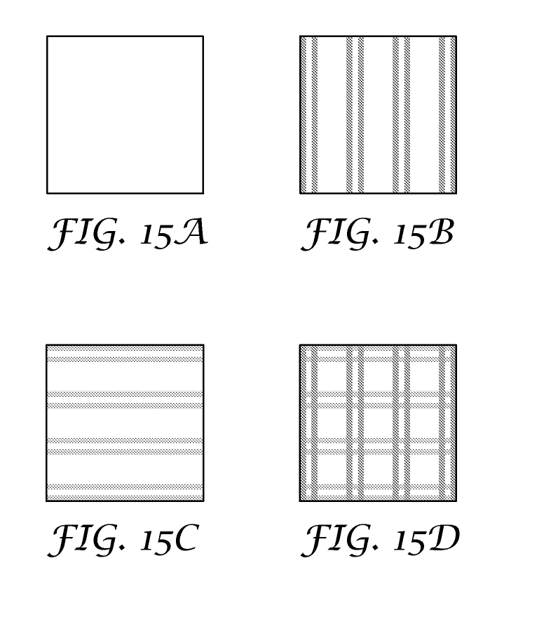

Two PDLC layers were prepared as described in “Preparation of Patterned PDLC” with a series of parallel lines forming the pattern as illustrated in FIG. 15A-15D. The PDLC layers were laminated onto clear acrylic using 3M 8141 OCA.

Extraction Layer

Printed clear extraction layers are prepared as described in Example 1 with the pattern in the printed clear extraction layers selected to match the line patterns in the PDLC layers. A printed clear extraction layer is then laminated to each of the PDLC films using 3M 8141 OCA such that the patterns in the PDLC films and the patterns in the printed clear extraction layers align. The two patterned layers with extractor layers are laminated together using 3M 8141 OCA with the parallel lines in one layer perpendicular to the parallel lines in the other layer and with the printed extractor side of each layer was facing in the same direction (up). The pattern in each layer are independently switched from clear to hazy by the application of voltage across the leads of each layer.

All U.S. patent applications and publications cited in the present application are incorporated herein by reference as if fully set forth. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

What is claimed is:

1. An optical stack, comprising:
a lightguide;
a light extraction layer optically coupled to the lightguide having first and second regions, the first and second regions being disposed such that the variable index light extraction layer selectively extracts guided mode light from the lightguide based on the geometric arrangement of the first and second regions; and
a polymer dispersed liquid crystal layer optically coupled to the light extraction layer having third and fourth regions, wherein at least one of the third and fourth regions has a haze value dependent on a voltage applied to the at least one of the third and fourth regions of the polymer dispersed liquid crystal layer;
wherein one or more of the first and second regions of the light extraction layer is in registration with one or more of the third and fourth regions of the polymer dispersed liquid crystal layer.

2. The optical stack of claim 1, wherein being in registration comprises having the same shape.

3. The optical stack of claim 1, wherein being in registration comprises having an areal overlap of at least 50% from a plan view.

4. The optical stack of claim 1, wherein at least one of the first, second, third, and fourth regions comprises a logo.

5. The optical stack of claim 1, wherein at least two of the first, second, third, and fourth regions comprise a logo.

6. The optical stack of claim 5, wherein the at least two of the first, second, third, and fourth regions comprise the same logo.

7. The optical stack of claim 1, further comprising one or more light sources configured to inject light into the lightguide.

8. The optical stack of claim 1, wherein at least one of the lightguide, variable index light extraction layer, and polymer dispersed liquid crystal layer comprises fiducials.
